(19) United States
(12) Patent Application Publication
(10) Pub. No.: US 2020/0286170 A1
(43) Pub. Date: Sep. 10, 2020

(54) Realtime Settlement Platform

(71) Applicant: Transparent Chain, Inc., Seattle, WA (US)

(72) Inventors: Jeffrey A. Kramer, Redmond, WA (US); István Fülöp, Seattle, WA (US); Alexander R. Fowler, San Francisco, CA (US); Shawn C.D. Johnson, Winchester, MA (US)

(73) Assignee: Transparent Chain,, Inc., Seattle, WA (US)

(21) Appl. No.: 16/295,377

(22) Filed: Mar. 7, 2019

(51) Int. Cl. G06Q 40/04; G06Q 40/06; G06Q 40/02; G06Q 20/36

(52) U.S. Cl. CPC G06Q 40/04; G06Q 20/3678; G06Q 40/02; G06Q 40/06

(57) ABSTRACT

Provided are an apparatus, method and programming product for transferring a financial asset over a distributed network that includes transferring a first financial asset from an first account at a first financial institution to a first trust account at the first financial institution; minting, at the first financial institution, a stablecoin based upon a value of the financial asset; transferring, over the distributed network, the stablecoin to a second trust account at a second financial institution; receiving at the first financial institution an acknowledgement of a smelting, at the second financial institution, the stablecoin to generate a second financial asset; and transferring, at the second financial institution, the second financial asset from the second trust account to a second account at the second financial institution.

### FIELD OF THE DISCLOSURE

The claimed subject matter relates generally to a financial platform and, more specifically, to a system that provides rapid exchange of currency between parties in a manner that minimizes risk and provides confidentiality.

### BACKGROUND

There are several types of financial structures for the investment and transfer of currency. A first financial structure is a mutual fund, which is regulated by the Securities Exchange Commission (SEC) and simply combines investors' assets into a fund. The most common example is a mutual fund that owns stocks. As the prices of the stocks in the fund rise and fall, the price of the mutual fund will also rise and fall. A particular type of mutual fund is a Money Market Fund (MMF), also known as a 2(a)7 fund (referring to the paragraph in the Code of Federal Regulation that describes this special type of fund). One of the characteristics of a MMF is that its price remains fixed at one U.S. dollar ($1.00) by highly restricting what the fund is allowed to purchase. For example, the fund is limited to owning debt securities which mature in thirteen (13) months or sooner. Under normal conditions, these debt securities don't vary much in price. Nonetheless, debt securities are marked-to-market every day. At the end of every day, the manager of the fund compares the market value of the securities in the fund to the book value of the money that was put into the fund by investors. This is called the Market-to-Book (M/B) ratio. So long as the M/B ratio remains 0.995 or higher, the SEC permits the fund to move investors into and out of the fund at a price of $1.00. If the M/B ratio ever falls below 0.995, the fund must ‘float’ its price, which means investors will realize a loss.

Many corporate treasurers invest the corporation's excess cash in MMFs. Corporate treasurers are always trying to find the highest yielding MMF, although they also try and pay attention to exactly what the funds holds in the way of investments. Investments that produce higher yield usually do so because they are riskier. Therefore, a prudent corporate treasurer might not invest in the highest yielding MMF, but typically invests in a collection of different MMFs.

A second financial structure is another type of mutual fund called an Exchange Traded Fund (ETF). Unlike other mutual funds, which are priced at the end of each day once the stock market closes, ETFs are priced throughout the day and trade like a stock. A legal aspect that allows this behavior is that the assets of the ETF are held in a trust. The shares of the trust are listed on a stock exchange just like a normal company. The trust also has a trustee, which administers and manages the trust.

A third financial structure is a cryptocurrency (or crypto currency), which is a digital asset that works as a medium of exchange. Strong cryptography is employed to secure financial transactions, control the creation of additional units of the cryptocurrency, and verify the transfer of assets. Cryptocurrencies use decentralized control as opposed to centralized control typically employed by central banking systems. Decentralized control of cryptocurrency often works through distributed ledger technology, typically a blockchain, a digital ledger in which transactions are recorded and that serves as a public financial transaction database. Currently, transactions are verified by either a “Proof of Work” (PoW) algorithm of “Proof of Stake” (PoS) algorithm. Those with skill in the relevant arts should understand these two types of transaction verification.

A stablecoin is a cryptocurrency designed to minimize price volatility. Stablecoins are used as stores of value or units of account, as well as in other use cases where volatile cryptocurrencies may be less desirable. Stablecoins may use different designs to achieve price stability. For example, the value of a stablecoin may be pegged to fiat currencies, or to exchange traded commodities (such as gold, silver, other precious and industrial metals, etc). Stablecoins may be centralized, i.e., backed by fiat and exchange-traded commodities directly, or decentralized by leveraging other cryptocurrency projects in different ways. In some ways, stablecoins are intended to act like shares in a MMF. That is, the users want a stablecoin to be worth a fixed amount, such as $1, backed by currency or precious commodity such as gold held in a bank. In some ways, stablecoins are intended to act like this. That is, stablecoins are meant to represent a holders' interests in the cash or commodity that is in sitting in a ‘vault’ (i.e. a bank). In the alternative, a stablecoin may merely represent the right to redeem cash or commodity from a fund.

### SUMMARY

Provided is a financial payment system, or “Real Time Settlement Platform” (RTSP), based on a construct adapted from several existing legal structures, and shares characteristics of a money market fund and an Exchange Traded Fund (ETF). RTSP merges blockchain technology with current banking technology to create an entirely new payment method. The system enables one user to transfer value to another user in two seconds or less, anywhere in the world. The platform mitigates risk and is designed to allow for fast settlement worldwide with confidentaility, and allows for non-bank regulated financial institutions to participate on an even footing with banking entities.

RTSP employs a stablecoin, herein referred to as “TransCoin.” RTSP does not pay interest to holders of TransCoins, which because of that and additional reasons, distinguishes it from a security. A trust is created to hold all the assets backing TransCoin, which ensures that no assets are ever held by the company managing the system, or the “operating company.” Only regulated financial institutions participate in the process of exchanging currency to and from TransCoin, thus maintaining an Anti-Money Laundering and Know Your Customer (AML/KYC) relationship with all end-users of TransCoin.

Provided are an apparatus, method and programming product for transferring a financial asset over a distributed network that includes transferring a first financial asset from an first account at a first financial institution to a first trust account at the first financial institution; minting, at the first financial institution, a stablecoin based upon a value of the financial asset; transferring, over the distributed network, the stablecoin to a second trust account at a second financial institution; receiving at the first financial institution an acknowledgement of a smelting, at the second financial institution, the stablecoin to generate a second financial asset; and transferring, at the second financial institution, the second financial asset from the second trust account to a second account at the second financial institution.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of two parties that participate in the disclosed technology, specifically an Authorized Participant (AP) and an AP client.

FIG. 2 is a block diagram of an Real Time Settlement Platform (RTSP) Architecture that may implement the claimed subject matter.

FIG. 3 is a block diagram of a Real Time Settlement Flow (RTSF) that illustrates the workings of the RTSP of FIG. 2.

FIG. 4 is a flowchart of a “Settlement” process that implements aspects of the claimed subject matter.

FIG. 5 is a flowchart that explains the creation, or “minting” of a TransCoin.

FIG. 6 is a flowchart that explains the redemption, or “smelting” of a TransCoin.

FIG. 7 is a flowchart of a “Transfer Funds process that implements aspects of the claimed subject matter.

### DETAILED DESCRIPTION OF THE FIGURES

The present invention may be implemented as a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As the Inventors herein have recognized, current banking and payment systems have a number of problems that don't allow them to serve today's twenty-four hour/seven day a week (24/7) global business environment. The Federal Reserve Wire Network (FedWire) is expensive and only available during limited hours, while Automated Clearing House (ACH) is cheaper, but may take three to five (3-5) days to settle. Current private real time payment systems, such as ZELLE®, operated by Early Warning Services of Scottsdale, Ariz. or Real Time Payments (RTP), operated by the Clearing House of New York, N.Y., suffer from strong capital requirements to support the shadow banking system at the Fed and cannot support non-bank financial institutions. Other common payment mechanisms such as credit and debit cards may be expensive, while debit is also hampered by overlapping and confusing requirements.

The standard international payment system of correspondent banking also has many problems—a chain of banks is required, payments may be misrouted or lost, and it can take days for the money to reach the destination. Even newer systems, like Ripple, operated by Ripple Labs of San Francisco, Calif., have flaws—banks and other financial institutions (FIs) must purchase a native currency of Ripple, or XRP, in order to utilize the system as well as requiring a market to trade against on the receiving side. Other systems that enable money to move internationally are both expensive and necessitate assuming the credit risk associated with a particular system. In other words, trust in the organization (like Western Union) to fulfill its requirements in all jurisdictions is required.

Current blockchains also present issues. Blockchains fall into two major camps along the privacy axis—nearly public and totally anonymous. A nearly public blockchain (like Bitcoin or Ethereum) enables a kind of financial panopticon—everyone's transactions and addresses are visible to everyone at all times. This is an obvious fault in confidentiality that all parties in the current banking system are eager to avoid. Anonymous blockchains (like Monero or ZCash) allow for secrecy, but may prevent oversight from appropriate regulators. While useful for private activities, such systems may not be able to comply with a subpoena. The disclosed system enables both confidentiality for network participants, while also allowing regulators to selectively audit transactions as per established norms, rules and laws for access to financial systems and data.

While the disclosed system may share some similarities with stablecoins (Tether, GeminiUSD, CENTREUSD, many others), current systems rely on taking risk to the operating organization, as well as the bank that underlies the system. The disclosed system is risk mitigating, as the operating organization never handles the money, and the multiple AP/multiple bank system is not as fragile—the more entities that are added, the less risky the system becomes.

In this Specification, a “settlement” is a transfer of funds from one user to another and consists of multiple actions between the participants, explained in more detail below. An “authorized participant,” or “AP,” is a regulated financial entity authorized to create or destroy stablecoins and authorized to validate users' post Anti-Money Laundering and Know Your Customer (AML/KYC) checks. Examples of APs include, but are not limited to, commercial banks, credit unions, stock brokerage firms, asset management firms, insurance companies and finance companies. Only APs are permitted to implement settlements. A “user” is a person or entity who has an account, or “wallet,” or who can otherwise access the provided services. In this Specification, a “wallet” is not a true wallet as understood in the art of blockchain but rather a partitioning of an AP's true wallet, held in a standard database or ledger at the AP. A “Validated User,” or “VU,” is a user that has been approved by an AP. A “nonce” is a number that has never been used before in a transaction between two APs/VUs. A “key” is a cryptographically significant set of random numbers in which duplicates are highly unlikely. A “transaction” is employed to implement a settlement and includes required information, i.e., an amount of funds to be transferred, a public key of a sender's AP, a public key of a receiver's AP and a nonce.

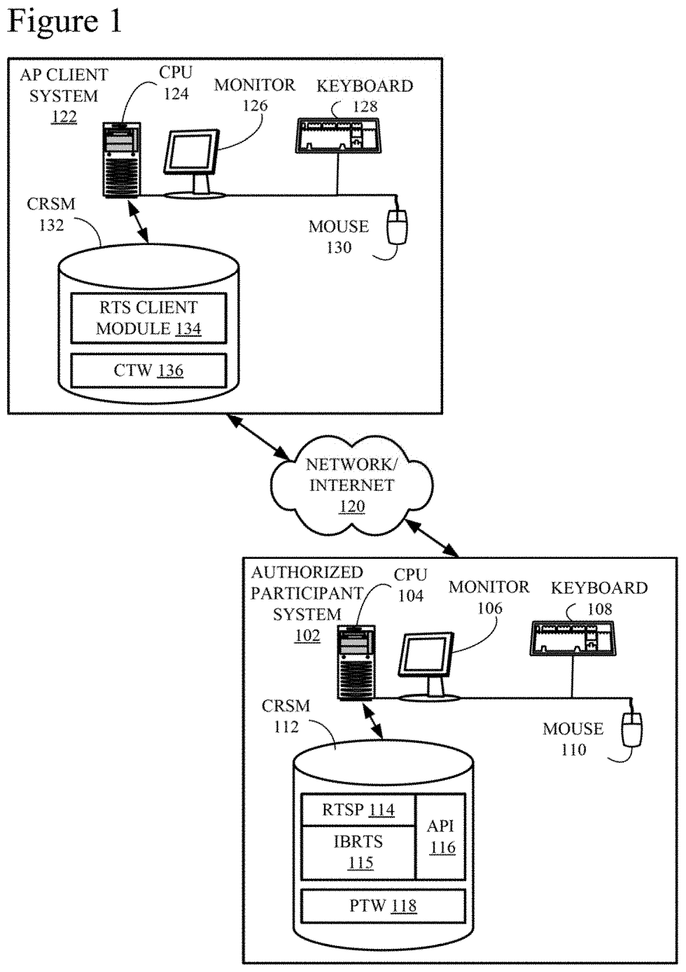

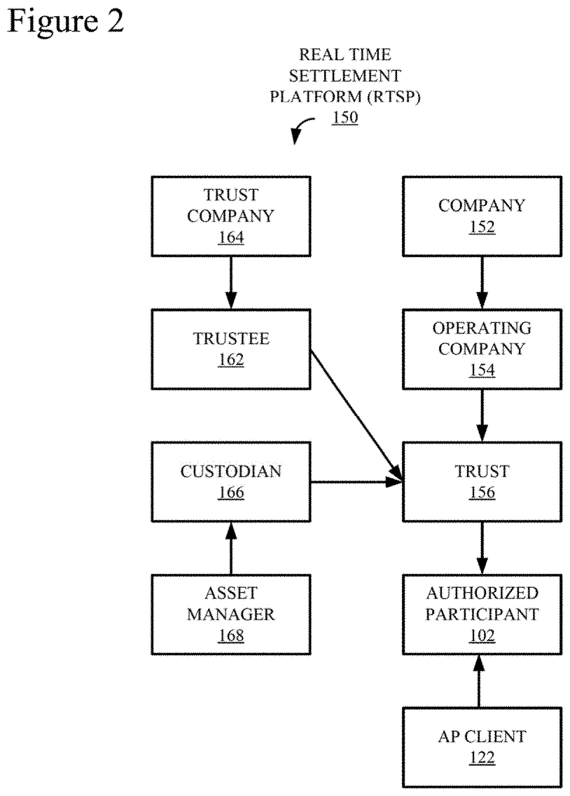

Turning now to the figures, FIG. 1 is a block diagram of two systems involved in a typical implementation of the disclosed technology, specifically an Authorized Participant (AP) system 102 and an AP client system 122. AP system 102 includes a central processing unit (CPU) 104, coupled to a monitor 106, a keyboard 108 and a pointing device, or “mouse,” 110, which together facilitate human interaction with computing system 100 and computing system 102. Also included in computing system 102 and attached to CPU 104 is a computer-readable storage medium (CRSM) 112, which may either be incorporated into computing system 102, i.e. an internal device, or attached externally to CPU 104 by means of various, commonly available connection devices such as but not limited to, a universal serial bus (USB) port (not shown). CRSM 112 is illustrated storing a Real Time Settlement Participant module, or simply RTSP 114 and an Intra-bank Real Time System (IBRTS) module, or simply IBRTS 115. RTSP 114 is typically accessed through an application programming interface (API) 116 and works in conjunction with other components of a Real Time Settlement Platform Architecture (RTSPA) (see 150, FIG. 2). CRSM 112 is also illustrated storing a participant cryptocurrency account, or “wallet,” which in this example is labeled as a Participant TransCoin Wallet (PTW) 118.

AP system 102 and CPU 104 are connected to communication medium, i.e., Network/Internet 120, which may be a network, the Internet of any other type of network that provides connectivity between computing systems. APC 122 is also coupled to Network/Internet 120. Like AP system 102, APC system 122 includes a CPU 124, a monitor 126, a keyboard 128, a mouse 130 and a CRSM 132. CRSM 132 is illustrated a RTS Client module, or simply RTSC 134. RTSC 134 typically works in conjunction with RTSP 114 via API 116 to interact with other components of RTSPA 150, including IBRTS 115. CRSM 132 is also illustrated storing a Client TransCoin wallet, or CTW 136, which is owned by a user of AP Client system 122.

Although in this example, systems 102 and 122 are communicatively coupled via Network/Internet 122, they could also be coupled through any number of communication mediums such as, but not limited to, a local area network (LAN), wide area network (WAN) (not shown), direct wire and wireless systems. It should be understood that AP 102, RTSP 114, IBRTS 115, AP 122, RTSC 134 and the other elements of FIG. 1 are merely used throughout the Specification as examples to describe the functionality of the disclosed technology.

FIG. 2 is a block diagram of an Real Time Settlement Platform (RTSPA) 150 that may implement the claimed subject matter. RTSPA 150 is merely used as one simple example of an architecture that may support the claimed subject matter. A typical payment support architecture would likely have many more components, including potentially thousands or more clients and hundreds or more authorized participants. The particular components shown in FIG. 2 are merely used as examples throughout the remainder of the Description.

A Company 152 is responsible for providing the software that administers RTSPA 150. The software includes, but is not limited to, providing a cryptocurrency stablecoin, which in this example is named “TransCoin.” An Operating Company 154 is established by Company 152 acts as a regulated entity so that Company 152 is not subject to financial regulations. Company 152 licenses software to Operating Company 154 that enables TransCoin, whose price, as a stablecoin, in not intended to fluctuate, e.g., one (1) TransCoin is equal to one U.S. dollar ($1). Operating Company may have the right to sublicense the software from Company 152 to other entities within RTSPA 150.

Operating Company 154 acts as a financial senior by establishing a Trust 156. As the settlor, Operating Company 154 appoints a Trustee 162 for Trust 156. Typically, Trustee 162 would be a regulated U.S. bank with trust powers, or Trust Company 164. The job of Trustee 162 is to administer Trust 156 by holding cash that backs TransCoin. In other words, cash backing TransCoin is held by Trust 156 in much that same way that gold sits in a vault to back an Exchange Traded Fund (ETF). In this manner, the cash backing TransCoin does not sit on a balance sheet of Operating Company 154 but rather on the balance sheet of Trust 156.

Trust 156 has a Custodian 166 and an Asset Manager 168 is appointed to manage assets of a Custodial account. Trust 156 and all its accounts, which may be deposit accounts at multiple banks and the custodial account, are audited by an independent Certified Public Accountant (CPA). The CPA periodically attests to the value of the assets in all accounts and transactions. For example, Asset Manager 168 may be Price Waterhouse Cooper (PWC), which may attest to the accuracy of the cash balances backing TransCoin reported continuously in the internet.

As explained in more detail below, TransCoins are created, or “minted,” or redeemed, or “smelted,” by Authorized Participants, such as AP 102 (FIG. 1) on behalf of AP Clients, such as AP Client 122 (FIG. 1). APs are independent, and unrelated, regulated U.S. financial institutions such as, but not limited to, banks, broker/dealers, money transmitters and money service businesses. It should be noted that within RTSPA 150 Operating Company is not able to either mint or smelt TransCoins. A Marketing Agent 172 is responsible for attracting APs and AP Clients into RTSPA 150.

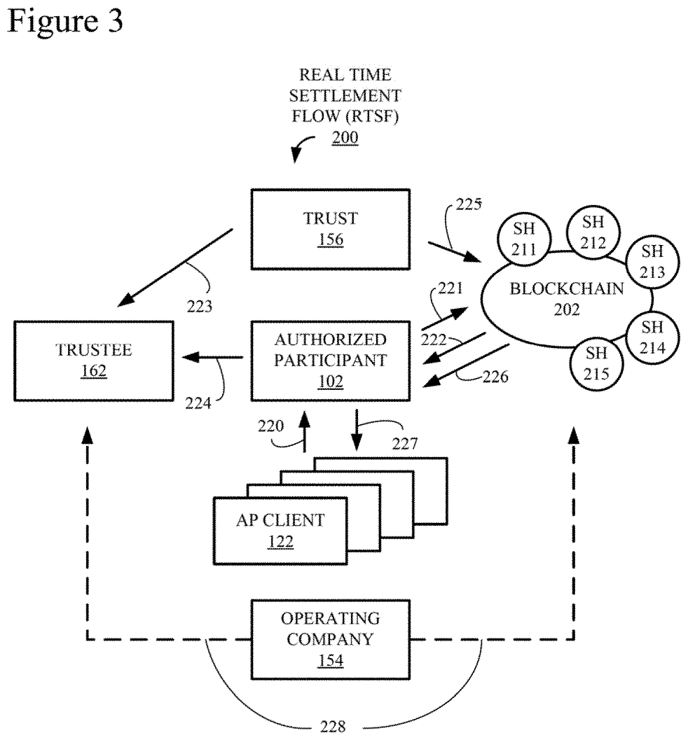

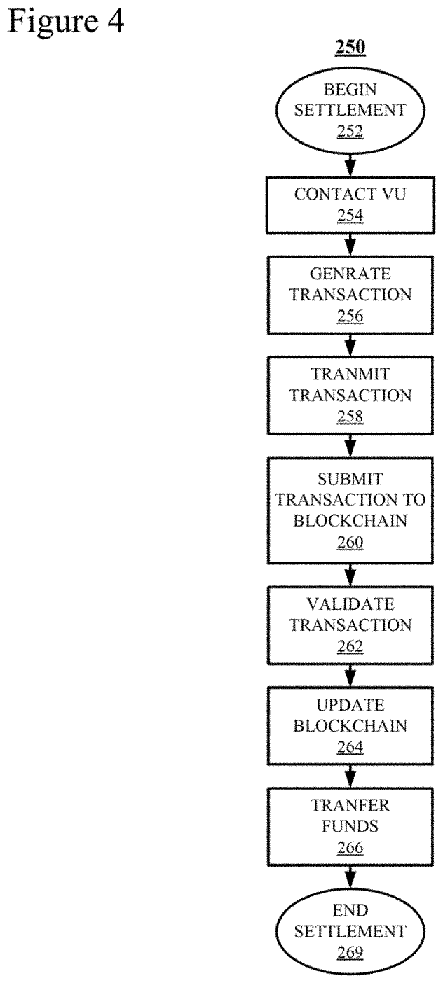

FIG. 3 is a block diagram of a Real Time Settlement Flow (RTSF) 200 that illustrates the workings of the RTSP of FIG. 2. Included in FIG. 3 are AP 102 (FIGS. 1&2), AP Client 122 (FIGS. 1&2), Operating Company 154 (FIG. 3), Trust 156 (FIG. 2) and Trustee 162 (FIG. 2). Multiple AP Clients 122 are shown although for the sake of simplicity only one is labeled. Also illustrated is a block chain 202 and associated Stakeholders (SHs) 211-215. Blockchain 202, stakeholders 211-215 and transactions 220-227 are explained in detail below in conjunction with FIG. 4. A transaction 228 indicates that Operating Company 154 audits activities on blockchain 202 and Trustee 162 by monitoring the movement of assets, thereby providing oversight of RTSF 200.

FIG. 4 is a flowchart of a “Settlement” process 250 that implements aspects of the claimed subject matter. In this example, various actions associated with process 250 are implemented on the entities illustrated in RTSP 150 (FIG. 2). When relevant, the specific entities of each action are identified. Process 250 is initiated by a one VU, referred to as the “sender” or “VU1,” who wishes to transfer funds to another VU, referred to as the “receiver” or “VU2.”

Settlement process 250 starts in a “Begin Settlement” block 252 and proceeds immediately to a “Contact VU” block 254. During block 254, VU1 and VU2 craft a nonce off-chain with each other, in which the VUs agree on an unused nonce and reveal their respective public keys between themselves. An “off-chain” message is a communication that is not part of a typical blockchain process. During processing associated with a “Generate Transaction” block 256, VU1 and VU2 each prepare a transaction by including in a their respective transaction messages, the amount of the funds to be transferred, VU1's public key, VU2's public key and the nonce that was agreed upon during processing associated with block 254.

During processing associated with block “Transmit Transaction” block 258, both VU1 and VU2 transmit the transaction each prepared during processing associated with block 254 to their respective APs 102 (FIGS. 1-3). During processing associated with a “Submit Transaction to Blockchain” block 260, each AP 102 that received the transaction during processing associated with block 258 signs the transaction with its private key and submits the signed transaction to blockchain 202 (FIG. 3) for validation. It should be understood that prior to the submission to blockchain 202, each AP 202 has authorized the corresponding VU by one or more methods know to those with skill in the relevant arts.

During processing associated with a “Validate Transaction” block 262, transactions generated by VU1 and VU2 during processing associated with block 256 are compared by validators such as SHs 211-215 (FIG. 3) to determine that they match and are therefore valid. Once the transactions are determined to be valid, processing proceeds to an “Update Blockchain” block 264. During processing associated with block 264, blockchain 202 is updated with the results of the transaction. Once blockchain 202 has been updated, each AP 102 updates its respective wallet.

During processing associated with a “Transfer Funds” block 266, the nonce associated with the transaction enables each AP 102 to update their internal ledgers with the funds either withdrawn or deposited with the corresponding VU. The nonce, which is known to both VU1 and VU2 is the information that links the two halves of the transaction together. Finally, processing proceeds to an “End Settlement” block 269 in which process 250 is complete. The disclosed technology respects user confidentiality because a nonce is not reused but enables transparent transactions among APs 102 because all APs 102, VUs and Validators are able to see the flow of funds between APs 102.

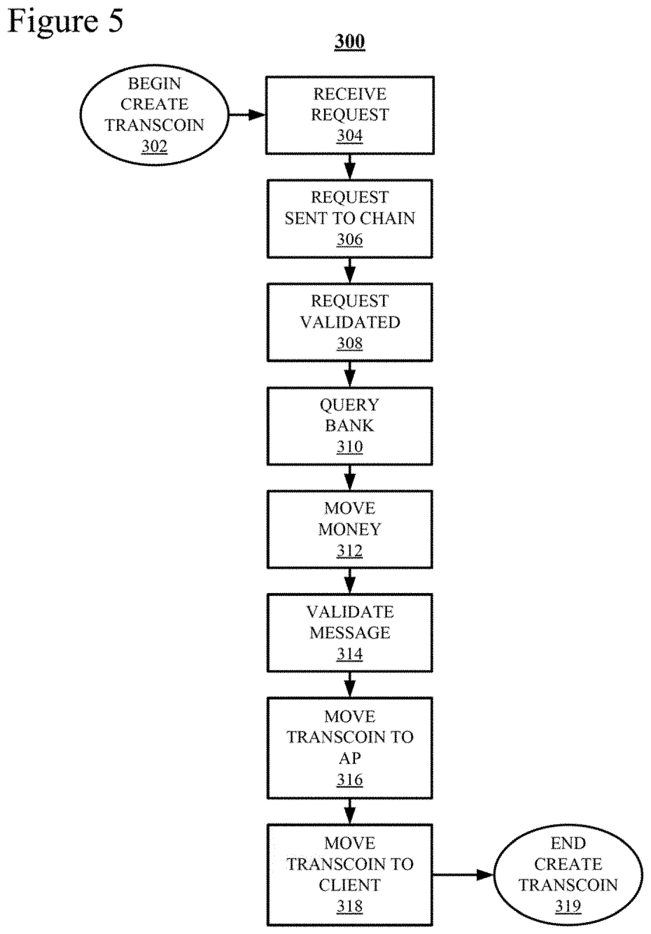

FIG. 5 is a flowchart of a “Create TransCoin” process 300 that explains some transactions 221-227 of RTSF 200 of FIG. 3 in greater detail. Process 300 starts in a “Begin Create TransCoin” block 302 and proceeds immediately to a “Receive Request” block 304 (see 220, FIG. 3). During processing associated with block 304, an AP Client such as AP Client 122 (FIGS. 1-3), transmits to AP 102 (FIGS. 1-3) a request for delivery of a TransCoin in exchange for, in this example U.S. dollars. Typically, AP Client 122 would have an account (not shown) or credit line (not shown) at AP 102 that has sufficient funds to cover the request. Such a request is typically transmitted by RTSC 134 to RTSP 114 via API 116. It should be understood that although U.S. dollars are used as an example throughout the Specification, the claimed subject matter is equally applicable to other forms of currency, including, but not limited to foreign currencies and cryptocurrencies.

During processing associated with a “Request Sent to Chain” block 306 (see 221, FIG. 3), RTSP 114 digitally signs and sends a transaction request to mint stablecoins such as TransCoin with a nonce to Blockchain 202 (FIG. 3). A nonce is an arbitrary number used in authentication procedures of cryptographic communication that can only be used once, thereby ensuring that an old communication cannot be reused in a replay attack.

During processing associated with a “Request Validated” block 308 (see 222, FIG. 3), stakeholders 211-215 (FIG. 3) validate the request to blockchain 202 sent during processing associated with block 306 based upon the digital signature and the nonce. Although process 300 only illustrates processing associated with an approval, an request determined to be invalid would trigger appropriate error processing and process 300 would typically terminate. During processing associated with a “Query Bank” block 310 (see 223, FIG. 3), Trustee 162 (FIG. 2), detects the request transmitted during processing associated with block 306 and validated during processing associated with block 308 on blockchain 202 and looks for the expected transaction and corresponding nonce at Trustee 162 (FIGS. 2&3) via an application programming interface (API) of Trustee 162.

During processing associated with a “Move Money” block 312 (see 224, FIG. 3), AP 102, detecting that stakeholders 211-215 have validated the request, moves money from an account of AP 122 at Trustee 162 into Trust 156, which in this example is also at Trustee 162, using IBRTS 115 (FIG. 1), including the nonce in the transaction. During processing associated with a “Validate Message” block 314 (see 225, FIG. 3), Trustee 162 detects the transaction performed during processing associated with block 312, verifies that the amount and the nonce of the transaction are correct and, if verified, digitally signs and publishes on blockchain 202 a message confirming the minting of a TransCoin.

During processing associated with a “Move TransCoin to AP” block 316 (see 226, FIG. 3), stackholders 151-155 validate the message transmitted by Trustee 162 during processing associated with block 314 thereby approving the minting of a TransCoin. The minted TransCoin is then added to TCW 116 (FIG. 1) of AP 102 at Trustee 162. During processing associated with a “Move TransCoin to Client” block 318 (see 227, FIG. 3), the Trancoins minted during processing associated with block 314 and moved to TCW 136 (FIG. 1) of AP 102 is then moved to CTW 136 of AP Client 122, who is the party that transmitted the request for a TransCoin during processing associated with block 304, employing standard crytocurrency transfer procedures. Finally, during processing associated with an “End Create TransCoin” block 319, process 300 is complete.

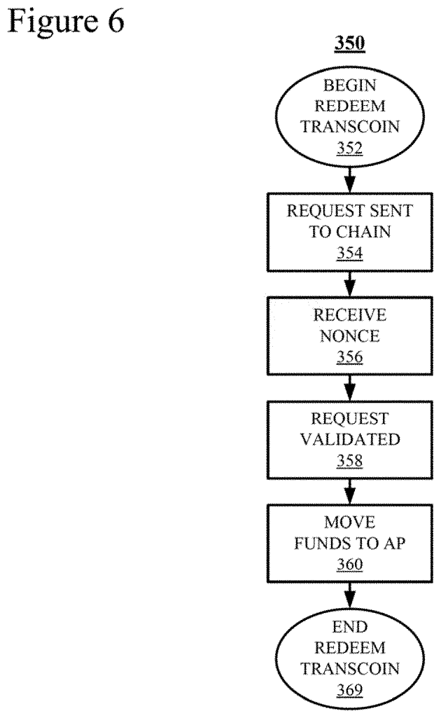

FIG. 6 is a flowchart of a “Redeem TransCoin” process 350 that explains transactions involved in redeeming, or “smelting,” a TransCoin. Process 350 starts in a “Begin Redeem TransCoin” block 352 and proceeds immediately to a “Request Sent to Chain” block 354. During processing associated with block 354, an AP such as AP 102 (FIGS. 1-3) transmits a notice, or “burn notice,” to blockchain 202 (FIG. 3) indicating a request to redeem a TranCoin into an appropriate currency or funds. During processing associated with a “Receive Nonce” block 356, AP 102 receives a nonce that is used to validate the request. During processing associated with a “Request Validated” block 358, stakeholders 211-215 (FIG. 3) validate the request based upon a digital signature and the nonce and enter the resulting transaction into blockchain 202. During processing associated with a “Move Funds to AP” block 360, Trustee 162 (FIGS. 2&3) moves funds into an account of AP 122 at Trustee 162.

During processing associated with a “Move Money” block 312 (see 224, FIG. 3), AP 102, detecting that stakeholders 211-215 have validated the request, moves money from an account of AP 122 at Trustee 162 into Trust 156, which in this example is also at Trustee 162, using IBRTS 115 (FIG. 1), including the nonce in the transaction. During processing associated with a “Validate Message” block 314 (see 225, FIG. 3), Trustee 162 detects the transaction performed during processing associated with block 312, verifies that the amount and the nonce of the transaction are correct and, if verified, digitally signs and publishes on blockchain 202 a message confirming the minting of a Transcoin.

During processing associated with a “Move Transcoin to AP” block 316 (see 226, FIG. 3), stackholders 151-155 validate the message transmitted by Trustee 162 during processing associated with block 314 thereby approving the minting of a Transcoin. The minted Transcoin is then added to TCW 116 (FIG. 1) of AP 102 at Trustee 162. During processing associated with a “Move Transcoin to Client” block 318 (see 227, FIG. 3), the Trancoins minted during processing associated with block 314 and moved to TCW 136 (FIG. 1) of AP 102 is then moved to CTW 136 of AP Client 122, who is the party that transmitted the request for a Transcoin during processing associated with block 304, employing standard crytocurrency transfer procedures. Finally, during processing associated with an “End Create Transcoin” block 319, process 300 is complete.

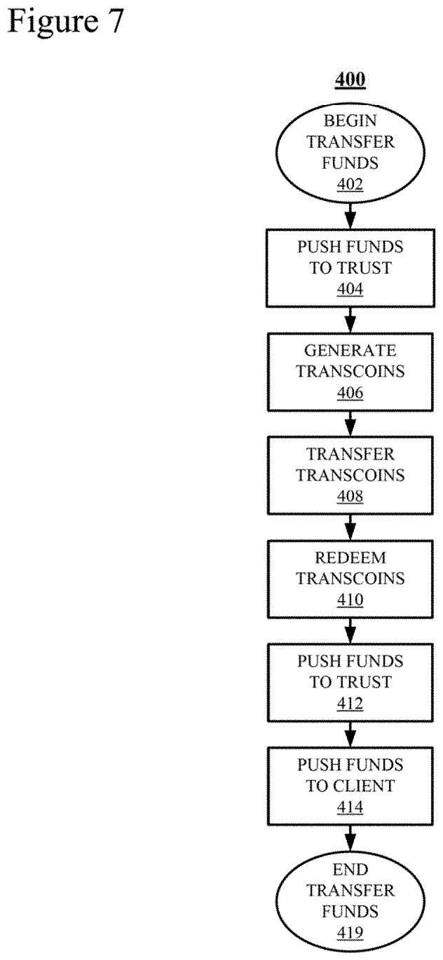

FIG. 7 is a flowchart of a “Transfer Funds process 400 that implements aspects of the claimed subject matter. In the disclosed technology, only APs such as AP 102 (FIGS. 1-3) may submit a transaction, i.e., initiate process 400. Process 400 starts in a “Begin Transfer Funds” block 402 and proceeds immediately to a “Push Funds to Trust” block 404. During processing associated with block 404, AP 102 transfers money of other funds into an account of Trustee 162 (FIGS. 2&3) at Trust 156 (FIGS. 2&3). During processing associated with a “Generate TransCoins” block 406, AP 102 request the creation, or minting, of an appropriate number of TransCoins (see 300, FIG. 5).

During processing associated with a “Transfer TransCoins” block 408, the TransCoins minted during processing associated with block 406 are transferred to the AP 102 associated with the receiving party (see 250, FIG. 4). During processing associated with a “Redeem TransCoins” block 410, the AP 102 associated with the receiving party, redeems, or smelts, the received TransCoins (see 350, FIG. 6). During processing associated with a “Push Funds to Trust” block 414, the funds generated from the TransCoins smelted during processing associated with block 410 are transferred to Trust 156 of Trustee 162. During processing associated with a “Push Funds to Client” block 414, the funds deposited in Trust 156 are moved to the receiving client such as AP client 122 (FIG. 1). Finally, process 400 proceeds to an “End Transfer Funds” block 419 in which process 400 is complete.

The disclosed real time settlement system provides many capabilities that are not supported by existing systems. Examples include nearly instant payroll clearing (pay hourly workers every hour vs. once every two weeks), business-to-business (B2B) accounts receivable and accounts payable settlements directly from one department to another and securities trading such as ETF Settlements in real-time, avoiding the 3-day cost of capital paid today. Additional examples include foreign exchange capabilities, e.g., facilitating currency exchange via Euro Coins, GBP Coins, Yen Coins, etc., person-to-person (P2P) fund transfers, i.e., individuals sending funds to each other, consumer payments that enable merchants to accept payments without being subject to high credit card fees, faster and cheaper payments processing for Government Programs such as Social Security, Supplemental Nutrition Assistance Program (SNAP) and Electronic Benefits Transfer (EBT) and international remittances and dispersal of aid and relief funds.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method for transferring a financial asset over a distributed network, comprising:
transferring a first financial asset from an first account at a first financial institution to a first trust account at the first financial institution;
minting, at the first financial institution, a stablecoin based upon a value of the financial asset;
transferring, over the distributed network, the stablecoin to a second trust account at a second financial institution;
receiving at the first financial institution an acknowledgement of a:
smelting, at the second financial institution, the stablecoin to generate a second financial asset; and
transferring, at the second financial institution, the second financial asset from the second trust account to a second account at the second financial institution.

2. The method of claim 1, further comprising verifying the transfer of the first financial asset to the first trust account prior to the minting, transferring to the second trust, the smelting and the transfer to the second account.

3. The method of claim 1, wherein:
the second financial asset is a different currency that the first financial asset;
the minting is performed based upon a first exchange rate corresponding to the first financial asset and the stablecoin; and
the smelting is performed based upon a second exchange rate corresponding to the second financial asset and the stablecoin.

4. The method of claim 1, wherein a value of the stablecoin is based upon the United States dollar.

5. The method of claim 1, further comprising monitoring, by a trustee, transactions associated with the first and second trust accounts.

6. The method of claim 1, further comprising receiving the financial asset and a request to perform the method from a client of the first financial institution.

7. The method of claim 1, wherein the first and second financial institutions are each one of a type of institution from a list of types of financial institutions, the list consisting of:
a bank; and
a credit union.

8. A apparatus for transferring a financial asset over a distributed network, comprising:
a processor;
a non-transitory computer-readable storage medium; and
instructions stored on the computer-readable storage medium and executed on the processor for performing a method, the method comprising:
transferring a first financial asset from an first account at a first financial institution to a first trust account at the first financial institution;
minting, at the first financial institution, a stablecoin based upon a value of the financial asset;
transferring, over the distributed network, the stablecoin to a second trust account at a second financial institution;
receiving at the first financial institution an acknowledgement of a:
smelting, at the second financial institution, the stablecoin to generate a second financial asset; and
transferring, at the second financial institution, the second financial asset from the second trust account to a second account at the second financial institution.

9. The apparatus of claim 8, the method further comprising verifying the transfer of the first financial asset to the first trust account prior to the minting, transferring to the second trust, the smelting and the transfer to the second account.

10. The apparatus of claim 8, wherein:
the second financial asset is a different currency that the first financial asset;
the minting is performed based upon a first exchange rate corresponding to the first financial asset and the stablecoin; and
the smelting is performed based upon a second exchange rate corresponding to the second financial asset and the stablecoin.

11. The apparatus of claim 8, wherein a value of the stablecoin is based upon the United States dollar.

12. The apparatus of claim 8, the method further comprising monitoring, by a trustee, transactions associated with the first and second trust accounts.

13. The apparatus of claim 8, the method further comprising receiving the financial asset and a request to perform the method from a client of the first financial institution.

14. The apparatus of claim 8, wherein the first and second financial institutions are each one of a type of institution from a list of types of financial institutions, the list consisting of:
a bank; and
a credit union.

15. A computer programming product for transfering a financial asset over a distributed network, comprising a non-transitory computer-readable storage medium having program code embodied therewith, the program code executable by a plurality of processors to perform a method comprising:
transferring a first financial asset from an first account at a first financial institution to a first trust account at the first financial institution;
minting, at the first financial institution, a stablecoin based upon a value of the financial asset;
transferring, over the distributed network, the stablecoin to a second trust account at a second financial institution;
receiving at the first financial institution an acknowledgement of a:
smelting, at the second financial institution, the stablecoin to generate a second financial asset; and
transferring, at the second financial institution, the second financial asset from the second trust account to a second account at the second financial institution.

16. The computer programming product of claim 15, the method further comprising verifying the transfer of the first financial asset to the first trust account prior to the minting, transferring to the second trust, the smelting and the transfer to the second account.

17. The computer programming product of claim 15, wherein:
the second financial asset is a different currency that the first financial asset;
the minting is performed based upon a first exchange rate corresponding to the first financial asset and the stablecoin; and
the smelting is performed based upon a second exchange rate corresponding to the second financial asset and the stablecoin.

18. The computer programming product of claim 15, wherein a value of the stablecoin is based upon the United States dollar.

19. The computer programming product of claim 15, the method further comprising monitoring, by a trustee, transactions associated with the first and second trust accounts.

20. The computer programming product of claim 15, the method further comprising receiving the financial asset and a request to perform the method from a client of the first financial institution.
